(19) United States
(12) Patent Application Publication
(10) Pub. No.: US 2026/0031619 A1
(43) Pub. Date: Jan. 29, 2026

(54) SYSTEMS AND METHODS FOR MONITORING AND CONTROLLING ELECTRICAL NETWORKS

(71) Applicant: Richards Mfg. Co. Sales, LLC, Irvington, NJ (US)

(72) Inventors: David DeLeo, Scotch Plains, NJ (US); Franklin Miller, Morris Plains, NJ (US)

(21) Appl. No.: 19/271,408

(22) Filed: Jul. 16, 2025

Related U.S. Application Data
(60) Provisional application No. 63/676,015, filed on Jul. 26, 2024.

(51) Int. Cl. H02J 3/00; H02J 3/38; H02J 13/00

(52) U.S. Cl. CPC H02J 3/0012; H02J 3/38; H02J 13/00002; H02J 13/00028; H02J 13/0004

(57) ABSTRACT

An electrical network includes a plurality of distribution transformers, a plurality of network protectors each electrically connected to one of the distribution transformers, a secondary bus electrically connected to each of the plurality of network protectors, and a control unit. The control unit is configured to receive data from each of the plurality of network protectors associated with electricity flowing therethrough, analyze the data to determine whether an electrical imbalance exists at any of the network protectors, and operate any imbalanced network protectors to disconnect the distribution transformers connected to the imbalanced network protector from the secondary bus. The control unit is further configured to permit beneficial backflow through the distribution transformers that may be created by generators coupled to the secondary bus.

### RELATED APPLICATIONS

This application claims the benefit of and priority to U.S. Provisional Patent Application No. 63/676,015 filed Jul. 26, 2024, the disclosure of which is incorporated herein by reference as if set forth in its entirety.

### FIELD OF THE INVENTION

The present disclosure relates generally to electrical network monitoring and control, and more particularly, to electrical network monitoring and control to allow backflow towards one or more primary feeders.

### BACKGROUND

Electrical networks utilize network protectors to prevent backflow of electricity into distribution transformers and back toward the substation due to faults in the electrical network or due to scheduled primary feeder outages. However, if the load being powered by the electrical network has its own electricity generation capabilities (e.g., solar panels, etc.), the excess electricity cannot be sent to other electrical loads, as the network protectors prevent backflow of the excess electricity.

In recent years, there has been a significant expansion of distributed generation (DG) equipment into more and more customer sites, some of which are served by underground secondary networks. Historically, secondary networks have been designed as a “one-way” system transferring power from the substation source via medium voltage network feeders through network transformers and network protectors ultimately to the customer load. Conventionally, network operators would not allow DG sites to be sized in excess of the customer's minimum load without employing some alternative method to ensure that the net power flow was always into the customer's site. This may be less than ideal as any excess generation capacity cannot be used to provide power to other customers.

One way to allow network protectors to function in a “two-way” manner where power can either flow to or from the customer site, but ultimately still perform their primary role of isolating the network and feeder in response to both primary fault conditions and normal substation switching operations is to set the allowable reverse power flow setting in the network protector relay to something much higher than would be used for normal network operations. This will allow the protector to remain closed under a moderate reverse power flow condition and still trip in response to most faults. However, during a switching operation where the substation breaker is opened manually (i.e., for maintenance rather than fault interruption), the protector would stay closed causing the feeder to remain energized. To mitigate this, remote communications to the network protector can be employed to establish a transfer trip scheme wherein the opening of the feeder breaker causes a trip message to be sent to all network protectors on the effected feeder to trip and block themselves open, thus isolating the feeder from the secondary network.

Such a system has drawbacks, including the expense of implementing remote communication, the complexity of implementing the transfer trip on the utility SCADA (Supervisory Control and Data Acquisition) end, and the inherent reliability problems that come with remote communications. Thus, there is a need for a system and method for autonomously monitoring and controlling backflow of electricity in an electrical network.

### SUMMARY OF THE INVENTION

According to some implementations of the present disclosure, an electrical network comprises; one or more primary feeders configured to receive electricity from a primary substation; a plurality of distribution transformers electrically connected to the one or more primary feeders, each of the plurality of distribution transformers being configured to receive the electricity from the one or more primary feeders and step down a voltage of the electricity; a plurality of network protectors, each of the plurality of network protectors being electrically connected to a respective one of the plurality of distribution transformers to receive the electricity, each of the plurality of network protectors being configured to generate data associated with one or more electrical characteristics of the electricity flowing therethrough; a secondary bus electrically connected to each of the plurality of network protectors such that the plurality of distribution transformers are electrically connected to the secondary bus through the plurality of network protectors; and a control unit communicatively coupled to each of the plurality of network protectors. The control unit is configured to receive the data from each of the plurality of network protectors; analyze the data to monitor the electricity flowing through each of the plurality of network protectors; and in response to determining that an electrical imbalance exists at an imbalanced one of the plurality of network protectors, operating the imbalanced network protector to disconnect the secondary bus from the respective distribution transformer connected to the imbalanced network protector. The control unit is further configured to determine from the data when no electrical imbalance exists, and then allow beneficial backflow to flow through one of more of the plurality of network protectors.

An electrical network comprises two or more primary feeders configured to receive electricity from a primary substation; a plurality of distribution transformers electrically connected to the two or more primary feeders, each of the plurality of distribution transformers being configured to receive the electricity from the two or more primary feeders and step down a voltage of the electricity; a plurality of network protectors, each of the plurality of network protectors being electrically connected to a respective one of the plurality of distribution transformers to receive the electricity, and operable to prevent backflow of the electricity to the respective distribution transformer, each of the plurality of network protectors being configured to generate data associated with one or more electrical characteristics of the electricity flowing therethrough; a secondary bus electrically connected to each of the plurality of network protectors such that the plurality of distribution transformers are electrically connected to the secondary bus through the plurality of network protectors; and a control unit communicatively coupled to each of the plurality of network protectors. The control unit is configured to receive the data from each of the plurality of network protectors; analyze the data to monitor the electricity flowing through each of the plurality of network protectors; identify, based on the analysis of the data, a group of imbalanced network protectors of the plurality of network protectors where an electrical imbalance exists; identify, based on the analysis of the data, a group of balanced network protectors of the plurality of network protectors where no power imbalance exists; and operate the group of imbalanced network protectors to disconnect the secondary bus from the respective distribution transformer electrically connected to each of the group of imbalanced network protectors. The control unit is further configured to determine from the data when no electrical imbalance exists, and then allow beneficial backflow to flow through one of more of the plurality of network protectors.

A control unit for use in an electrical network that includes a plurality of network protectors each electrically connected to a respective distribution transformer and all electrically connected to a secondary bus comprises a communication interface configured to communicatively couple the control unit to each of the plurality of network protectors; a processing device; and a memory device storing computer-readable instructions that when executed by the processing device, cause the control unit to: receive data from each of the plurality of network protectors associated with electricity flowing through each of the plurality of network protectors; analyze the data to monitor the electricity flowing through each of the plurality of network protectors; and in response to determining that an electrical imbalance exists at an imbalanced one of the plurality of network protectors, operating the imbalanced network protector to disconnect the secondary bus from the respective distribution transformer connected to the imbalanced network protector.

A control unit for use in an electrical network that includes a plurality of network protectors each electrically connected to a respective distribution transformer and all electrically connected to a secondary bus comprises a communication interface configured to communicatively couple the control unit to each of the plurality of network protectors; a processing device; and a memory device storing computer-readable instructions that when executed by the processing device, cause the control unit to: receive data from each of the plurality of network protectors associated with electricity flowing through each of the plurality of network protectors; analyze the data to monitor the electricity flowing through each of the plurality of network protectors; identify, based on the analysis of the data, a group of imbalanced network protectors of the plurality of network protectors where an electrical imbalance exists; identify, based on the analysis of the data, a group of balanced network protectors of the plurality of network protectors where no power imbalance exists; and operate the group of imbalanced network protectors to disconnect the secondary bus from the respective distribution transformer electrically connected to each of the group of imbalanced network protectors.

An electrical network comprises two or more primary feeders configured to receive electricity from a primary substation; a plurality of distribution transformers electrically connected to the two or more primary feeders, each of the plurality of distribution transformers being configured to receive the electricity from the two or more primary feeders and step down a voltage of the electricity; a plurality of network protectors, each of the plurality of network protectors being electrically connected to a respective one of the plurality of distribution transformers to receive the electricity, and operable to prevent backflow of the electricity to the respective distribution transformer, each of the plurality of network protectors being configured to generate data associated with one or more electrical characteristics of the electricity flowing therethrough; and a secondary bus electrically connected to each of the plurality of network protectors such that the plurality of distribution transformers are electrically connected to the secondary bus through the plurality of network protectors, wherein one of the plurality of network protectors is a controlling network protector, and wherein the controlling network protector is configured to: receive the data from all other network protectors of the plurality of network protectors; analyze the data to monitor the electricity flowing through itself and through all the other network protectors; and in response to determining that an electrical imbalance exists at an imbalanced one of the plurality of network protectors, operating the imbalanced network protector to disconnect the secondary bus from the respective distribution transformer connected to the imbalanced network protector.

An electrical network comprises two or more primary feeders configured to receive electricity from a primary substation; a plurality of distribution transformers electrically connected to the two or more primary feeders, each of the plurality of distribution transformers being configured to receive the electricity from the two or more primary feeders and step down a voltage of the electricity; a plurality of network protectors, each of the plurality of network protectors being electrically connected to a respective one of the plurality of distribution transformers to receive the electricity, and operable to prevent backflow of the electricity to the respective distribution transformer, each of the plurality of network protectors being configured to generate data associated with one or more electrical characteristics of the electricity flowing therethrough; and a secondary bus electrically connected to each of the plurality of network protectors such that the plurality of distribution transformers are electrically connected to the secondary bus through the plurality of network protectors, wherein one of the plurality of network protectors is a controlling network protector, and wherein the controlling network protector is configured to: receive the data from all other network protectors of the plurality of network protectors; analyze the data to monitor the electricity flowing through itself and through all the other network protectors; and identify, based on the analysis of the data, a group of imbalanced network protectors of the plurality of network protectors where an electrical imbalance exists; identify, based on the analysis of the data, a group of balanced network protectors of the plurality of network protectors where no power imbalance exists; and operate the group of imbalanced network protectors to disconnect the secondary bus from the respective distribution transformer electrically connected to each of the group of imbalanced network protectors.

A method of operating an electrical network, wherein the electrical network includes a plurality of network protectors each electrically connected to a respective distribution transformer and all electrically connected to a secondary bus, comprises receiving, at a control unit communicatively coupled to each of the plurality of network protectors, data associated with electricity flowing through each of the plurality network protectors; analyzing the data to monitor the electricity flowing through each of the plurality of network protectors; and in response to determining that an electrical imbalance exists at an imbalanced one of the plurality of network protectors, sending a control signal, via the control unit, to the imbalanced network protector to disconnect the secondary bus from the respective distribution transformer connected to the imbalanced network protector.

A method of operating an electrical network, wherein the electrical network includes a plurality of network protectors each electrically connected to a respective distribution transformer and all electrically connected to a secondary bus, comprises receiving, at a control unit communicatively coupled to each of the plurality of network protectors, data associated with electricity flowing through each of the plurality network protectors; analyzing the data to monitor the electricity flowing through each of the plurality of network protectors; identifying, based on the analysis of the data, a group of imbalanced network protectors of the plurality of network protectors where an electrical imbalance exists; identifying, based on the analysis of the data, a group of balanced network protectors of the plurality of network protectors where no power imbalance exists; and sending a first control signal, via the control unit, to the group of imbalanced network protectors to disconnect the secondary bus from the respective distribution transformer electrically connected to each of the group of imbalanced network protectors.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. The above summary is not intended to represent each implementation or every aspect of the present disclosure. Additional features and benefits of the present disclosure are apparent from the detailed description and FIGURES set forth below.

### BRIEF DESCRIPTION OF THE DRAWINGS

The disclosure, and its advantages and drawing, will be better understood from the following description of representative embodiments together with reference to the accompanying drawing. This drawing depicts only representative embodiments and is therefore not to be considered as limitations on the scope of the various embodiments or claims.

FIG. 1 is a block diagram of an electrical network, according to aspects of the present disclosure.

While the present disclosure is susceptible to various modifications and alternative forms, specific implementations and embodiments have been shown by way of example in the drawing and will be described in detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

Embodiments of the present invention provide systems and methods for collective monitoring of each network protector relay in a spot network. In each system, a local area network (LAN) will be established allowing communications between all network protector relays in the spot network and a master device. Communications between devices will be either a proprietary protocol or could use an industry standard such as IEC-61850. The master device can either be a standalone device or potentially be one of the network protector relays that is selected to be the master through an election algorithm.

Measurements from each relay (voltages, current, phase angles, power flow, etc.) will be sent to the master device which will monitor the system conditions sitewide. Under normal operation, either with or without the DG system operating, the power flow from each of the network protectors should be shared equally. The master device will monitor for any imbalances between the connected relays and command the one with the imbalance to trip and remain open for a period, after which the relay will revert back to its normal reclose parameters.

Various embodiments are described with reference to the attached FIGURE. The FIGURE is not necessarily drawn to scale and is provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

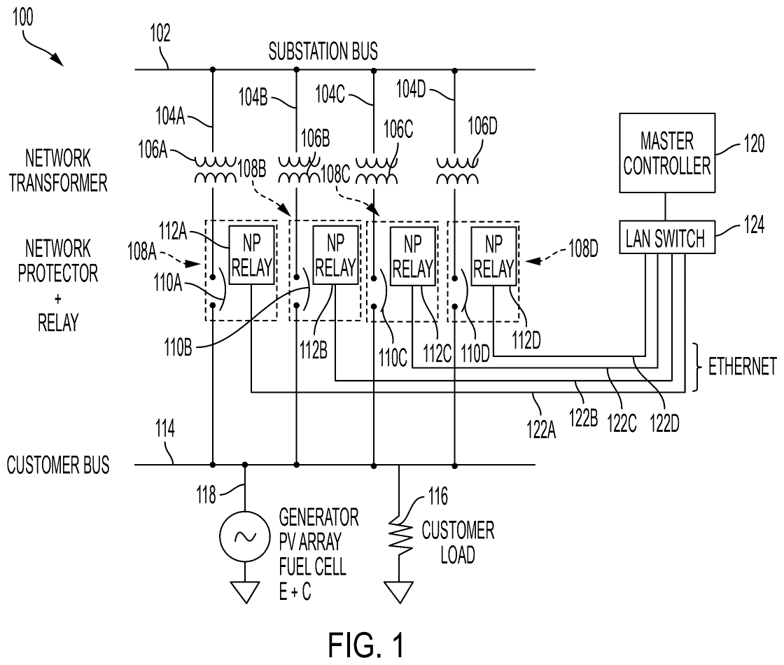

FIG. 1 is a block diagram of an electrical network 100, according to aspects of the present disclosure. The electrical network 100 includes a substation bus 102 which carries electricity from a substation. The substation bus 102 is electrically connected to a plurality of distribution transformers 106A-106D via a plurality of feeders 104A-104D. In the illustrated implementation, four feeders are connected to four distribution transformers, but generally the electrical network 100 may include any number of feeders connected to any number of distribution transformers, so long as there is at least two distribution transformers.

Each of the distribution transformers 106A-106D is connected to a secondary or customer bus 114 via one of a plurality of network protectors 108A-108D. Each network protector 108A-108D includes a corresponding network-protector mechanism (e.g., a switch) 110A-110D and an associated relay 112A-112D. The relay 112A is operable to control the associated mechanism 110A-110D to electrically connect and disconnect each of the distribution transformers 106A-106D from the secondary bus 114. The electronics within each relay 112A-D includes processing devices and any necessary components to measure various electrical characteristics of the electricity flowing through the corresponding network protector 108A-D, including the voltages, currents, phase angles, powers, and/or any other electrical characteristic or combination of characteristics. The network protectors 108A-108D can prevent backflow into the distribution transformers 106A-106D (which often occurs due to a fault somewhere in the electrical network 100, or due to a scheduled feeder outage) by opening the network-protector mechanisms 110A-110D, such that the distribution transformers 106A-106D are disconnected from the secondary bus 114.

The electrical network 100 further includes a customer load 116. In general, the secondary bus 114 connects the distribution transformers 106A-106D at a single large location, such as a large office building, a hospital complex, etc. The customer load 116 includes any devices that are powered using the electricity delivered from secondary bus 114, as well as any components or devices used to deliver the electricity to these devices.

The electrical network 100 further includes a customer generator 118. The customer generator 118 can include devices or systems that the customer may use for on-site power generation, such as solar panels (e.g., a photovoltaic array), fuel cells, etc. In some cases, if the customer generator 118 is generating more electricity than the customer load 116 is drawing, the excess electricity can flow back toward the network protectors 108A-108D.

Under normal operation, the network protectors 108A-108D are configured to open the network-protector mechanisms 110A-110D in response to backflow of electricity occurring (which may be detected by the electronics of the relays 112A-112D). However, backflow is not always due to a fault somewhere in the electrical network 100. Instead, backflow may be caused by excess generation of electricity by the customer generator 118, which may be beneficial as it can be routed to other feeders and/or other networks. Thus, the electrical network 100 further includes a master controller 120, which is a control unit that controls the network protectors 108A-108D so that the distribution transformers 106A-106D remain connected to the secondary bus 114 and receive backflow from the customer generator 118.

In the illustrated implementation, the network protectors 108A-108D are communicatively coupled to the master controller 120 via a plurality of Ethernet connections 122A-122D and a network switch 124. However, other suitable connections between the network protectors 108A-108D and the master controller 120 may be used. In some implementations, the network protectors 108A-108D and the master controller 120 communicate with each other via the IEC-61850 protocol, the DNP3 protocol, or any number of industry standard or custom protocols.

As noted herein, each of network protectors 108A-108D is configured to generate data associated with various different electrical characteristics of the electricity flowing therethrough. This data can be sent to the master controller 120, which analyzes the data to monitor the network protectors 108A-108D, and to identify any imbalances across the network protectors 108A-108D. An imbalance at a particular one of the network protectors 108A-108D generally indicates a fault somewhere along the corresponding feeder 104A-104D or in the distribution transformer(s) 106A-106D connected to the imbalanced network protector. Once the imbalanced network protector 108 (or a group of imbalanced network protectors 108) is identified, the master controller 120 can operate the imbalanced network protector 108 (for example by sending one or more control signals) to open the corresponding network-protector mechanism 110 and disconnect the secondary bus 114 from the distribution transformer 106 connected to the imbalanced network protector. The master controller 120 will cause the remaining network protectors 108 (e.g., the group of balanced network protectors) to keep their network-protector mechanisms 110 closed.

By controlling the operation of the network protectors 108A-108D, the master controller 120 can allow backflow of excess electricity generated by the customer generator 118 to occur. Generally, backflow caused by excess electricity generated by the customer generator 118 will not cause any of the network protectors 108A-108D to become imbalanced. However, backflow due to a fault upstream of the network protectors 108A-108D, or scheduled outage of the feeders 104A-D, in the electrical network 100 will generally cause one of the network protectors 108A-108D to become imbalanced, which can be detected by the master controller 120. Thus, instead of the network protectors 108A-108D automatically opening the network protector mechanisms 110A-110D in response to the detection of backflow, the control unit 120 operates the network protectors 108A-108D to keep the network protector mechanisms 110A-110D closed when beneficial backflow occurs due to the customer generator 118, but to open the network protector mechanisms 110A-110D when backflow due to a fault or scheduled outage occurs. For example, the master controller 120 allows backflow through certain ones of the network protectors 108A-108B, while preventing backflow through others of the network protectors 108C-108D.

The master controller 120 includes any suitable components needed to receive and analyze the data from the network protectors 108A-108D, and to control the network protectors 108A-108D. In some implementations, the master controller 120 includes a processing device, a memory device, and a communication interface that receives the data from the network protectors 108A-108D and can send control signals to the network protectors 108A-108D to operate the network protectors 108A-108D. The processing device may be, for example, a commercially available or custom microprocessor. Moreover, the processing device may include multiple processing devices. The memory device may be a non-transitory computer readable storage medium and may be representative of the overall hierarchy of memory devices containing the software and data used to implement various functions of the master controller 120 as described herein. The memory device may include, but is not limited to, the following types of devices: cache, ROM, PROM, EPROM, EEPROM, flash, static RAM (“SRAM”), and dynamic RAM (“DRAM”).

In some cases, the master controller 120 may also be communicatively coupled to the customer load 116 and/or customer generator 118, so that the master controller 120 may monitor the respective power flow and/or send control signals to the customer generator 118 to pause or modify operation of the customer generator 118 and/or to disconnect the customer generator 118 from the secondary bus 114.

The master controller 120 may identify imbalanced network protectors in any suitable manner. In some implementations, the master controller 120 determines the value of one or more electrical characteristics of each of the network protectors 108A-108D and compares those values to identify any imbalanced network protectors. In some cases, an imbalanced network protector is a network protector where the value of the electrical characteristic deviates by at least a threshold amount from an average value of the electrical characteristic across all the network protectors 108A-108D. In other cases, an imbalanced network protector is a network protector where the value of the electrical characteristic deviates by at least a threshold amount from a median value of the electrical characteristic across all the network protectors 108A-108D. In further cases, an imbalanced network protector is a network protector where the value of the electrical characteristic is outside of a predetermined acceptable range for the electrical characteristic.

In some cases, only one of the network protectors 108A-108D is determined to be imbalanced at a time. In other cases, the group of imbalanced network protectors may include multiple of the network protectors 108A-108D.

The master controller 120 can thus be used to monitor the electrical network 100. The control unit 120 can receive and analyze data associated with the electricity flowing through each of the network protectors 108A-108D. Based on this analysis, the master controller 120 can identify a group of one or more imbalanced network protectors where an electrical imbalance exists, and a group of one or more balanced network protectors where no electrical imbalance exists. The master controller 120 can send control signals to the imbalanced network protectors to cause them to disconnect their respective distribution transformers 106 from the secondary bus 114.

In some implementations, the electrical network 100 does not include a separate control unit 120 as illustrated in FIG. 1. Instead, one of the network protectors 108 can act as a controlling network protector and can carry out the functions of the master controller 120. For example, if the network protector 108A is the controlling network protector, the other network protectors 108B-108D can send their data to the controlling network protector 108A. The controlling network protector 108A can analyze the data from the other network protectors 108B-108D and its own data to identify any imbalanced network protectors. The controlling network protector 108A can then send a control signal to whichever network protector is imbalanced, so that that network protector can disconnect its distribution transformer 106 from the secondary bus 114. If the data indicates that the controlling network protector 108A itself is imbalanced, it can operate its own network protector mechanism 110A to disconnect the distribution transformer 106A from the secondary bus 114. In these implementations, generally any of the network protectors 108A-108D can be the controlling network protector. In some cases, the controlling network protectors is chosen via an election algorithm. For example, all of the network protectors 108A-108D may broadcast a static numeric value inherent to the network protectors (such as a serial number, MAC address, etc.), and the network protectors with the highest value is chosen as the controlling network protector.

One or more elements or aspects or steps, or any portion(s) thereof, from one or more of any of claims below can be combined with one or more elements or aspects or steps, or any portion(s) thereof, from one or more of any of the other claims or combinations thereof, to form one or more additional implementations and/or claims of the present disclosure.

While the present disclosure has been described with reference to one or more particular embodiments or implementations, those skilled in the art will recognize that many changes may be made thereto without departing from the spirit and scope of the present disclosure. Each of these implementations and obvious variations thereof is contemplated as falling within the spirit and scope of the present disclosure. It is also contemplated that additional implementations or alternative implementations according to aspects of the present disclosure may combine any number of features from any of the implementations described herein, such as, for example, in the alternative implementations described above.

Aspects and elements of all of the embodiments disclosed above can be combined in any way and/or combination with aspects or elements of other embodiments to provide a plurality of additional embodiments.

What is claimed is:

1. An electrical network comprising:
one or more primary feeders configured to receive electricity from a primary substation;
a plurality of distribution transformers electrically connected to the one or more primary feeders, each of the plurality of distribution transformers being configured to receive the electricity from the one or more primary feeders and step down a voltage of the electricity;
a plurality of network protectors, each of the plurality of network protectors being electrically connected to a respective one of the plurality of distribution transformers to receive the electricity, each of the plurality of network protectors being configured to generate data associated with one or more electrical characteristics of the electricity flowing therethrough;
a secondary bus electrically connected to each of the plurality of network protectors such that the plurality of distribution transformers are electrically connected to the secondary bus through the plurality of network protectors; and
a control unit communicatively coupled to each of the plurality of network protectors, the control unit being configured to:
receive the data from each of the plurality of network protectors;
analyze the data to monitor the electricity flowing through each of the plurality of network protectors; and
in response to determining that an electrical imbalance exists at an imbalanced one of the plurality of network protectors, operating the imbalanced network protector to disconnect the secondary bus from the respective one of the plurality of distribution transformers to prevent backflow through the imbalanced network protector.

2. The electrical network of claim 1, wherein in response to determining from the data that no electrical imbalance exists, the control unit is further configured to allow beneficial backflow to flow through one of more of the plurality of network protectors.

3. The electrical network of claim 1, wherein the control unit includes a processing device, a memory device, and a communication interface configured to (i) receive the data from each of the plurality of network protectors and (ii) transmit one or more control signals to each of the plurality of network protectors to operate each of the plurality of network protectors.

4. The electrical network of claim 3, wherein the communication interface is configured to communicate with the plurality of network protectors via IEC-61850 protocol, DNP3 protocol, or any other industry standard or custom protocol.

5. The electrical network of claim 3, wherein the control unit is communicatively coupled to a generator that is electrically connected to the secondary bus, the communication interface being further configured to monitor operation of and/or transmit one or more control signals to the generator to (i) pause operation of the generator, (ii) cause the generator to be disconnected from the secondary bus, (iii) modify the output of the generator or (iv) some combination of (i), (ii), and (iii).

6. The electrical network of claim 1, wherein to analyze the data, the control unit is further configured to:
determine, based on the data of each respective network protector, a value of at least one electrical characteristic associated with the electricity flowing through the respective network protector; and
compare the value of the at least one electrical characteristic for all of the plurality of network protectors to identify the imbalanced network protector.

7. The electrical network of claim 6, wherein the value of the at least one electrical characteristic of one of the plurality of network protectors being different than an average value of the at least one electrical characteristic across all of the plurality of network protectors by at least a threshold amount indicates that the one of the plurality of network protectors is imbalanced.

8. The electrical network of claim 6, wherein the value of the at least one electrical characteristic of one of the plurality of network protectors being different than a median value of the at least one electrical characteristic across all of the plurality of network protectors by at least a threshold amount indicates that the one of the plurality of network protectors is imbalanced.

9. The electrical network of claim 6, wherein the value of the at least one electrical characteristic of one of the plurality of network protectors being outside of a predetermined acceptable range for the at least one electrical characteristic indicates that the one of the plurality of network protectors is imbalanced.

10. The electrical network of claim 6, wherein the at least one electrical characteristic includes a voltage, a current, a phase angle, an amount of electrical power, harmonic measurement, rate of change of any of these parameters, or any combination thereof.

11. The electrical network of claim 1, wherein the control unit is a separate component from the plurality of network protectors.

12. The electrical network of claim 1, wherein the control unit is integrated with one of the plurality of network protectors.

13. The electrical network of claim 1, wherein the control unit is further configured to:
identify, based on the analysis of the data, a group of imbalanced network protectors of the plurality of network protectors where an electrical imbalance exists;
identify, based on the analysis of the data, a group of balanced network protectors of the plurality of network protectors where no power imbalance exists; and
operate the group of imbalanced network protectors to disconnect the secondary bus from the respective distribution transformer electrically connected to each of the group of imbalanced network protectors.

14. The electrical network of claim 13, wherein the group of imbalanced network protectors contains a single one of the plurality of network protectors.

15. The electrical network of claim 13, wherein the group of imbalanced network protectors contains two or more of the plurality of network protectors.

16. A control unit for use in an electrical network that includes a plurality of network protectors each electrically connected to a respective distribution transformer and all electrically connected to a secondary bus, the control unit comprising:
a communication interface configured to communicatively couple the control unit to each of the plurality of network protectors;
a processing device; and
a memory device storing computer-readable instructions that when executed by the processing device, cause the control unit to:
receive data from each of the plurality of network protectors associated with electricity flowing through each of the plurality of network protectors;
analyze the data to monitor the electricity flowing through each of the plurality of network protectors; and
in response to determining that an electrical imbalance exists at an imbalanced one of the plurality of network protectors, operating the imbalanced network protector to disconnect the secondary bus from the respective distribution transformer connected to the imbalanced network protector.

17. The control unit of claim 16, wherein the memory device further stores computer-readable instructions that when executed by the processing device, cause the control unit to:
identify, based on the analysis of the data, a group of imbalanced network protectors of the plurality of network protectors where an electrical imbalance exists;
identify, based on the analysis of the data, a group of balanced network protectors of the plurality of network protectors where no power imbalance exists; and
operate the group of imbalanced network protectors to disconnect the secondary bus from the respective distribution transformer electrically connected to each of the group of imbalanced network protectors.

18. A method of operating an electrical network that includes a plurality of network protectors each electrically connected to a respective distribution transformer and all electrically connected to a secondary bus, the method comprising:
receiving, at a control unit communicatively coupled to each of the plurality of network protectors, data associated with electricity flowing through each of the plurality network protectors;
analyzing the data to monitor the electricity flowing through each of the plurality of network protectors; and
in response to determining that an electrical imbalance exists at an imbalanced one of the plurality of network protectors, sending a control signal, via the control unit, to the imbalanced network protector to disconnect the secondary bus from the respective distribution transformer connected to the imbalanced network protector.

19. The method of claim 18, further comprising:
identifying, based on the analysis of the data, a group of imbalanced network protectors of the plurality of network protectors where an electrical imbalance exists;
identifying, based on the analysis of the data, a group of balanced network protectors of the plurality of network protectors where no power imbalance exists; and
sending a first control signal, via the control unit, to the group of imbalanced network protectors to disconnect the secondary bus from the respective distribution transformer electrically connected to each of the group of imbalanced network protectors.

20. The method of claim 18, wherein the control unit is a separate component from the plurality of network protectors or wherein the control unit is integrated with one of the plurality of network protectors.
